(19) United States
(12) Patent Application Publication
(10) Pub. No.: US 2007/0100496 A1
(43) Pub. Date: May 3, 2007

(54) Robot system, method and computer program product

(75) Inventor: Erik Forell, Stockholm (SE)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Stockholmsmassan, Stockholm (SE)

(21) Appl. No.: 10/557,517

(22) PCT Filed: May 26, 2004
(86) PCT No.: PCT/SE04/00811

§ 371 Date: Jan. 4, 2007

(30) Foreign Application Priority Data
May 27, 2003 (SE) 0301567-4

(51) Int. Cl. G06F 19/00

(52) U.S. Cl. 700/245; 701/23

(57) ABSTRACT

Robot system including at least one mobile robot (10), for treating a surface, which comprises map storage means to store a map of the surface to be treated and means to navigate the, or each, mobile robot (10) to at least one point on a surface. The, or each, mobile robot (10) comprises locating means (13,14) to identify its position with respect to the surface to be treated and means to automatically deviate the mobile robot (10) away from its initial path in the event that an obstacle is detected along its path. The, or each, mobile robot (10) also comprises means to store and/or communicate data concerning the surface treatment performed and any obstacles detected by the locating means (13,14).

### TECHNICAL FIELD OF THE INVENTION AND PRIOR ART

The present invention concerns a robot system including at least one mobile robot, for treating a surface, which comprises map storage means to store a map of the surface to be treated and means to navigate the, or each, mobile robot to at least one point on a surface. The, or each, mobile robot comprises locating means to identify its position with respect to the surface to be treated and emitting means for treating at least one point on that surface.

The present invention also relates to a method for treating a surface using such a robot system and a computer program product that contains computer program code means for making a computer or processor carry out the method according to the present invention. The use of the robot system or method is intended primarily, but not exclusively, for the treatment of a floor or the ground at a trade fair, exhibition or construction site.

An exhibition requires advance and careful planning of the available space at the exhibition venue. The physical layout of the exhibition is determined by the size, shape and quantity of exhibit stands with regard to the permanent fixtures at the exhibition venue such as entrances, exits and building columns. Once a floor plan has been finalized, marking it out is a time-consuming and expensive job which often has to be done during the evenings or weekends if the time between different exhibitions is short. The floor plan may also have to be altered while the exhibition is being organized if the type, number, size or shape of exhibits is changed or modified after the marking out work has begun.

In the construction and manufacturing industries a physical layout i.e. floor or ground plan is required to ensure the accurate placement of equipment, centre lines and interior partitions.

The customary method of marking out a physical layout involves the use of surveyors or field engineers to establish reference lines, usually by the transit and tape method. Detailing by transit and tape is however a very labour intensive process that often needs to be carried out by several people. More importantly it is prone to human error as regards reading and interpreting the blue print, determining distances and angles and performing the repeated calculations that are necessary for the production of an accurate physical layout.

U.S. Pat. No. 5,453,931 discloses a mobile robot and a method of producing a physical lay-out and reference lines or performing work on a plane surface through Cartesian co-ordinates. The mobile robot has an on-board computer that is programmed with locations that require treatment, work or equipment positioning. The mobile robot locates and treats the co-ordinates with emitting means, such as an ink jet type marking system to provide reference lines for workmen or for directly performing work at the co-ordinates.

One disadvantage of using such a mobile robot is that obstacles such as people, equipment or fixtures, whose location is not programmed into the mobile robot's computer, temporarily or permanently block the path that the mobile robot is programmed to follow thus interrupting or preventing its work until the obstacle is removed. Human interaction is therefore required during the surface treatment work to monitor the mobile robot and to clear its path of obstacles.

### SUMMARY OF THE INVENTION

The object of the present invention is to provide a robot system comprising at least one mobile robot for treating a surface, where the robot system does not need to be monitored during the surface treatment work but completes the work autonomously.

This object is achieved using a robot system having the features of claim 1 namely, a robot system including at least one mobile robot, for treating a surface, which comprises map storage means to store a map of a surface to be treated and means to navigate the, or each, mobile robot to at least one point on a surface. The map includes both the position and geometry of natural landmarks, such as pillars and walls, and artificial landmarks, such as poles, in the work area so that the, or each mobile robot can plan a path around the surface.

The, or each, mobile robot comprises long-range and/or short-range locating means to identify its position with respect to the surface to be treated. The, or each, mobile robot also comprises means to automatically deviate it away from its initial path in the event that an obstacle is detected by the locating means along its path. The locating means enable a mobile robot to detect its position with respect to the surface to be treated and to detect and judge the configuration of obstacles in its path. On receiving information about a mobile robot's surroundings from the locating means the robot system makes a decision as to the course of travel best for the, or each, mobile robot to avoid the obstacle so that it can continue with its work.

According to a preferred embodiment of the invention the, or each, mobile robot is used only to point out the position at which at least one point on a surface is to be treated allowing a person to carry out the treatment work at said at least one point. The expression “surface treatment” in the claims is therefore intended to cover the indication of a point on a surface ay which treatment work is to be carried out.

According to another preferred embodiment of the invention the, or each, mobile robot comprises emitting means that are arranged to dispense at least one of the following: ink, paint, glue, a gas, a liquid, a powder or light to mark, etch, decorate or chemically react with the surface to be treated. The emitting means leave either an optically detectable mark on the surface to be treated or a mark that is detectable only under particular conditions such as under UV-light illumination.

According to a yet further preferred embodiment of the invention the emitting means produce emissions such as symbols, lines, shapes, or written characters in one or more colours. The use of various markings or different colours is useful for marking different features of the physical layout. For example in an exhibition hall exhibit stands can be marked with continuous black lines, written text indicating which exhibit shall be placed within those lines can be plotted at the side of the continuous lines, optionally in an area that will not be carpeted over subsequently, and intermittent or differently coloured lines can be used to indicate the location of pieces of equipment or plumbing.

The robot system also comprises means to store and/or communicate data concerning the surface treatment performed and any obstacles detected by the locating means. The, or each, mobile robot can therefore be positioned in the work area and left to complete the surface treatment task. On completion of the task the, or each mobile robot reports on how successfully the task was completed i.e. on exactly how much of the surface treatment work was carried out and provides reasons why the remaining surface treatment was not executed.

Using such a robot system dramatically cuts the measurement time and site visits required to provide an accurate physical layout. The robot system allows less trained staff to be involved in the plotting or other work as it carries out the task autonomously and with a high degree of accuracy.

According to a preferred embodiment of the invention the, or each, mobile robot comprises an on-board computer including map storage means and means to store and/or communicate data concerning the surface treatment performed and any obstacles detected by the locating means. According to a further preferred embodiment of the invention the computer controls the means propelling the mobile robot and controls any emitting means provided thereon.

According to a yet further embodiment of the invention the, or each, mobile robot comprises wired or wireless communication means such as an electric or fibre optic cable, an antenna or Bluetooth™ hardware to communicate with a remote user, control system, computer or computer network or another mobile robot in order to notify an independent party of the situation encountered by the, or each, mobile robot either after a run or during a run to provide a constant update on the work being carried out by the, or each, mobile robot.

In a further embodiment of the invention the communication means are arranged to communicate that maintenance work needs to be carried out for example that a mobile robot's battery needs to be charged or that mechanical failure has occurred.

According to a preferred embodiment of the invention the communication means are arranged to report that an obstacle has been encountered by a mobile robot if the obstacle has not been removed after a pre-determined time such as a few seconds. This is advantageous in case people are moving or equipment is being shifted in the area in which the, or each, mobile robot is working.

According to another preferred embodiment of the invention the, or each mobile robot is programmed to return to an area in which an obstacle was detected after a pre-determined time to check whether the obstacle is still present and whether it is therefore still hindered from performing surface treatment in that area. If the obstacle has been removed the mobile robot consequently completes the surface treatment work. If the obstacle is still present the, or each, mobile robot is optionally programmed to return to the same site one or more times to check whether the area is still obstructed. Alternatively the information concerning the obstacle is stored or communicated to a remote user, control system, computer or computer network.

According to another preferred embodiment of the invention, if a plurality of mobile robots are used to carry out surface treatment in different parts of the same area the report concerning the work completed may be sent to one of the mobile robots so that a complete report concerning the entire surface covered by all the mobile robots is obtained from a single mobile robot.

According to a further embodiment of the invention the locating means comprise at least one of the following types of sensor; optical such as a laser or scanning laser, thermal imaging, electro-magnetic, sonar, a Global Positioning System (GPS), pressure, motion, angle-detection, contact or direction sensors.

According to a preferred embodiment of the invention the, or each, mobile robot traverses the surface to be treated on which a physical layout is to be plotted. Alternatively, the, or each, mobile robot traverses a surface other than the surface to be treated. For example the surface to be treated is a surface, such as wall, that is inclined or substantially perpendicular to a floor which the, or each, mobile robot traverses or the surface to be treated is a surface directly above or below the surface that the, or each, mobile robot traverses. The robot system of the present invention is suitable for the treatment of any type of surface both indoor or outdoor, flat or inclined, horizontal or vertical, even or uneven.

According to another preferred embodiment of the invention the, or each, mobile robot comprises deletion means, instead of, or in addition to the emitting means, which are arranged to remove emissions produced by the emitting means of the same or another mobile robot in the same or a previous run respectively. In this way the, or each, mobile robot may be programmed to delete some or all of the floor treatment it has carried out. This is advantageous if some part of the physical layout needs to be re-plotted.

The present invention also relates to a method for treating a surface using a robot system including at least one mobile robot. The method comprises inputting a map of a surface to be treated into a computer located on-board or remotely to the, or each, mobile robot, navigating the, or each, mobile robot to at least one point on a surface and treating that point for example with emitting means. The, or each, mobile robot draws up its own map of the surface using information collected from on-board or remote locating means and automatically deviates away from the initial path in the event that an obstacle is detected along its path. The, or each, mobile robot stores and/or communicates data concerning the surface treatment performed and the obstacles detected by the locating means.

According to a preferred embodiment of the invention the map and, if available, pre-programmed path data is inputted in the form of a file such as a file from a CAD-system.

According to a further preferred embodiment of the invention the, or each, mobile robot is programmed to return to an area in which an obstacle was detected after a predetermined time to check whether the obstacle is still present and whether it is therefore still hindered from performing surface treatment in that area. At the option of the user, the, or each, mobile robot may of course be programmed to return to the area containing an obstacle any number of times.

According to a yet further preferred embodiment of the invention the, or each, robot is instructed to return to areas in which an obstacle was identified after the obstacle has been removed. Such instruction is provided once the, or each, mobile robot has completed the rest of the surface treatment and the report of the work performed is analysed by a user or as soon as a user recognises that an obstacle is in the way of a mobile robot either from a signal provided by the mobile robot itself or in some other way.

A still further object of the invention is to provide a computer program product for use in a robot system including at least one mobile robot for treating a surface. The computer program product contains computer program code means for making a computer or processor carry out the method according to the present invention. The computer program product is stored by means of a computer-readable medium such as a data server, magnetic or magneto-optical storage means. According to a preferred embodiment of the invention the computer program product contains a map of a surface and optionally a pre-programmed path to direct the, or each, mobile robot around that surface.

According to another preferred embodiment of the invention the computer program product stores and/or communicates data concerning the surface treatment carried out by the, or each, mobile robot and data concerning obstacles detected along its path as well as instructions for any emitting means used to treat the surface.

The invention also relates to preferred uses of a robot system according to the invention defined in the appended use claims, namely for indicating or marking out a physical lay-out on any indoor or outdoor surface such as at an exhibition, a trade fair or construction site or for marking out a physical lay-out at any site under hygienic conditions or under conditions hazardous for human beings.

Further advantages and advantageous features of the invention will be apparent from the following description.

### BRIEF DESCRIPTION OF THE DRAWINGS

With reference to the appended drawings, below follows a specific description of preferred embodiments of the invention cited as examples.

FIG. 1 is a schematic diagram of a mobile robot according to a preferred embodiment of the invention, and

FIG. 2 shows a floor plan for an exhibition hall.

### DETAILED DESCRIPTION OF PREFERRED EMBODIMENTS OF THE INVENTION

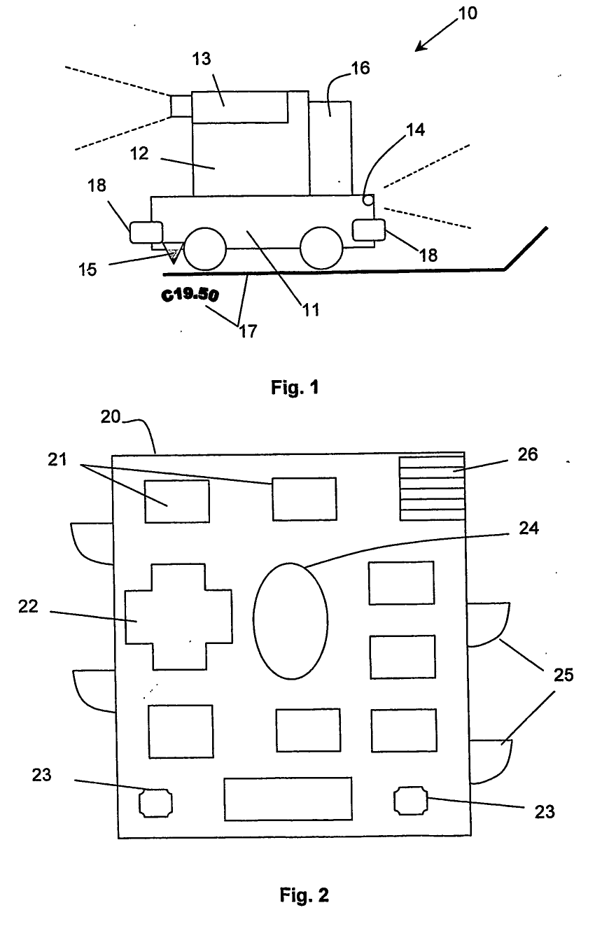

FIG. 1 shows a self-propelled mobile robot 10 for marking a surface comprising a four-wheel-drive platform 11, such as a Pioneer2 AT or (a two-wheel-drive) DXE. The mobile robot comprises an on-board computer 12 to process instructions from a user and information from the mobile robot's sensors and to navigate the mobile robot to at least one point on a surface and to communicate with another computer.

The mobile robot comprises locating means including a scanning laser 13 and a sonar 14 to enable the robot to detect its position with respect to the surface that is to be treated and to detect and judge the configuration of obstacles in its path. This is done by measuring the time it takes for a light or sound pulse to travel to and from an object that reflects the light or sound pulse, for example. The scanning laser preferably comprises means to be able to differentiate between different objects or different parts of the same object by detecting differences in the reflectivity of the different materials constituting those objects. According to a preferred embodiment of the invention further locating means, such as wheel encoders to measure the amount and direction of travel of the platform 11, are utilized.

The mobile robot also comprises an ink jet marking system having a printing head 15, an ink cartridge 16 to mark the surface and an air pump to pump ink from the ink cartridge to the printing head. The markings 17 produced on the surface are either temporary as in the case of an exhibition hall floor plan or advertisements, or permanent such as lines for a sports pitch, track or court or parking spaces in a car park. Information concerning when the ink cartridge 16 needs to be replaced is stored and/or communicated by the mobile robot 10.

The position of the tip of the printing head 15 is displaced and controlled by instructions from an on-board control system, via an RS232 serial interface for example. The mobile robot is told where to mark the surface using an XML-file directly from a CAD-system. The XML-file generally contains a collection of points that the mobile robot has to visit. Each point contains the position of the marking and information on the marking including any text that should be produced at each point. The XML-file also (optionally) describes a clockwise or anticlockwise path around the contours of the exhibit stands.

Once the mobile robot has reached one of the points at which a marking is to be made an instructed amount of ink is jetted at instructed timing from the printing head to produce the desired marking. The desired markings 17 are made when the mobile robot 10 is moving and/or when it is stationary and correspond to the position of an exhibit stand or a piece of equipment. The written characters provide further information to workmen who will then position the exhibit stand or equipment at that location. According to another preferred embodiment of the invention the mobile robot additionally comprises further tools for carrying out other types of surface treatment and/or for removing a surface treatment.

The robot system locates the position of the mobile robot by initiating the scanning laser 13 to estimate the position at which the mobile robot takes the laser scan. Odometric information from wheel encoders for example helps the robot system ascertain how a mobile robot has moved inbetween laser scans in order to facilitate estimation of the mobile robot's position. The robot system detects which of the landmarks shown in the map of the work area are visible in the laser scan, using an iterative closest point algorithm for example to match map data with measured data. The mobile robot's position is consequently updated.

According to a preferred embodiment of the invention at least part of the mobile robot's platform 11, emitting means 15 or locating means 13, 14 are capable of translational or rotational movement with respect to the main body of the mobile robot 10 to improve the mobile robot's access to each part of the surface to be marked and so as not to limit the detection range of its locating means.

The mobile robot 10 comprises means to automatically deviate the mobile robot away from its initial path in the event that an obstacle is detected along its path. The mobile robot is equipped with pressure-sensitive bumpers 18 to protect it in case of a collision.

The on-board computer 12 stores and/or communicates data concerning the markings carried out and any obstacles detected during the marking work. This is done by either storing such information in the on-board computer 12 for access by a user at the end of the marking work or by communicating the information, via an antenna to a remote computer or user while the information is being collected. Such information is of course overwritten or updated during a run if the mobile robot is programmed to return to an area in which it encountered an obstacle after a predetermined time to check whether the obstacle is still present and whether it is still prevented from carrying out work in that region. In a preferred embodiment of the invention a mobile robot is programmed to wait for a few seconds on detecting an obstacle and then to check whether the obstacle is still there so as not to be hindered by temporary obstacles such as people passing in front of the robot.

According to another preferred embodiment of the invention the mobile robot 10 comprises receiving and emitting means to allow the mobile robot 10 to communicate with a remote user, computer network or another mobile robot.

According to a preferred embodiment of the invention the mobile robot comprises a travel mechanism such as battery-driven, radio-controlled or mains-powered means to start, stop, move, lift, lower, rotate and change direction of the mobile robot. According to a further embodiment of the invention the mobile robot is equipped with a device for winding up a power supply chord, feed lines or communication cable if necessary.

FIG. 2 shows a floor plan for an exhibition hall 20. Such information is inputted into a robot system using a floppy disc or keyboard or via a network such as the Internet for example. The floor plan indicates the location of a number of exhibit stands 21, a restaurant 22, building columns 23, a central reception area 24, entrances and exits 25 and an escalator 26. Using a robot system simplifies the task of accurately plotting shapes such as an ellipse for reception area 24, such shapes being difficult to draw by hand.

Structures such as the polygonal building columns 23 can be problematic for the mobile robot's distance sensors. A building column is a relatively small structure that may prove difficult for a mobile robot's sensors to detect due to the small surface available for reflecting light or sound waves. Furthermore if a structure comprises surfaces that are not perpendicular to a mobile robot's sonar, only part of a sound wave from a sonar will be reflected towards the mobile robot. High accuracy distance measurements require not only information about which building column a sound wave was reflected from but also information on which points on the building column the sound wave was reflected from. The more complex the geometry of a particular structure, the harder it is to obtain accurate distance predications. The use of a combination of different, long-distance and proximity sensors can of course reduce this problem. Alternatively, one or more points or parts of a structure having a complex geometric shape is/are marked with reflective material, such as reflective tape, to strengthen the signals reflected from said points or parts of the structure in order to facilitate correspondence between data from the sensors and the robot system's map.

According to a preferred embodiment of the invention the mobile robot comprises a digital camera to collect an image of what is seen by the mobile robot which is then sent to and processed by a remote user.

According to a preferred embodiment of the invention, as the mobile robot 10 collects information concerning its surroundings, mobile robot guidance means above, below or on the surface which the mobile robot traverses are utilized to guide the mobile robot. For example guidance means such as raised or indented markings, buried electrical components (an electric characteristic of which may be detected) by the mobile robot or signal-emitting means. In the absence of permanent landmarks, such as walls and building columns, guidance means such as poles covered with a reflecting material may be provided to guide the mobile robot.

The mobile robot 10 travels around the exhibition hall changing direction according to a logical decision process which results in the mobile robot taking the shortest possible path to each of the points on the surface while avoiding all obstacles so that it performs the required surface treatment in the shortest possible time. The decision process relies solely on data collected from the mobile robot's sensors which is stored and/or communicated by the mobile robot. Once the mobile robot finds a clear path around an obstacle it calculates the speed at which it can safely pass the obstacle with regard to the number of obstacles in that area and its distance from them. The mobile robots path and speed is however altered if the mobile robot's sensors detect further obstacles while travelling along the initially decided path.

The physical layout shown in FIG. 2 can be marked out by one or more mobile robots. If the site is relatively large or if the plotting work is relatively complex a plurality of mobile robots may be used so as to complete the work more quickly. According to a preferred embodiment of the invention the mobile robots comprise means to communicate with one another in order to deduce their location using a trilateration technique whereby a mobile robot can deduce its location if it knows its distance from one or more mobile robots.

The invention is of course not in any way restricted to the preferred embodiments thereof described above, but many possibilities to modifications thereof would be apparent to a man with ordinary skill in the art without departing from the basic idea of the invention as defined in the appended claims.

What is claimed:

1. Robot system including at least one mobile robot (10), for treating a surface, which comprises map storage means to store a map of the surface to be treated and means to navigate the, or each, mobile robot (10) to at least one point on a surface, characterized in that the, or each, mobile robot (10) comprises locating means (13,14) to identify its position with respect to the surface to be treated, means to automatically deviate the mobile robot away from its initial path in the event that an obstacle is detected along its path, means to store and/or communicate data concerning the surface treatment performed and any obstacles detected by the locating means (13,14) and emitting means (15) that produce emissions (17) such as symbols, lines, shapes, or written characters in one or more colours for treating at least one point on a surface.

2. Robot system according to claim 1, characterized in that said emitting means (15) are arranged to dispense at least one of the following: ink, paint, glue, a gas, a liquid, a powder or light to mark, etch, decorate or chemically react with the surface to be treated.

3. Robot system according to claim 2, characterized in that the, or each, mobile robot (10) comprises an on-board computer (12) including map storage means and means to store and/or communicate data concerning the surface treatment performed and any obstacles detected by the locating means (13,14).

4. Robot system according to claim 3, characterized in that the, or each mobile robot (10) is programmed to return to an area in which an obstacle was detected after a pre-determined time to check whether the obstacle is still present and whether it is therefore still hindered from performing surface treatment in that area.

5. Robot system according to claim 4, characterized in that the locating means (13,14) comprise at least one of the following types of sensor; optical such as a laser, thermal imaging, electromagnetic, sonar, GPS, pressure, motion, angle detection, contact or direction sensors.

6. Robot system according to claim 5, characterized in that it comprises means to differentiate between different objects or different parts of the same object by detecting differences in the reflectivity of the different materials constituting those objects.

7. Robot system according to claim 6, characterized in that the, or each, mobile robot (10) comprises wired or wireless communication means such as an electric or optic cable, an antenna or Bluetooth™ hardware to communicate with a remote user, control system or computer network or another robot.

8. Robot system according to claim 7, characterized in that the communication means are arranged to report that an obstacle has been encountered by a mobile robot (10) if the obstacle has not been removed after a predetermined time such as a few seconds.

9. Robot system according to claim 8, characterized in that the, or each, mobile robot (10) traverses the surface to be treated.

10. Robot system according to claim 9, characterized in that the, or each, mobile robot. (10) traverses a surface other than the surface to be treated.

11. Robot system according to claim 10, characterized in that the, or each, mobile robot (10) comprises deletion means, instead of, or in addition to the emitting means (15), which are arranged to remove emissions (17) produced by the emitting means (15) of the same or another mobile robot (10) in the same or a previous run respectively.

12. Method for treating a surface using a robot system including at least one mobile robot (10), comprising inputting a map of a surface to be treated into a computer (12) located on-board or remotely to the, or each, mobile robot (10), navigating the, or each, mobile robot to at least one point on a surface, characterized in that the, or each, mobile robot (10) draws up a map of the surface using information collected from on-board or remote locating means (13,14) used to identify the position of the robot with respect to the surface to be treated and automatically deviates away from its initial path in the event that an obstacle is detected along its path, that the, or each, mobile robot (10) stores and/or communicates data concerning the surface treatment performed and the obstacles detected by the locating means (13,14) and that emissions (17) such as symbols, lines, shapes, or written characters in one or more colours are produced by emitting means (15) for treating at least one point on the surface.

13. Method according to claim 12, characterized in that map data and, if available, path data is inputted in the form of a file such as a file from a CAD-system.

14. Method according to claim 12, characterized in that the, or each, mobile robot (10) is programmed to return to an area in which an obstacle was detected after a predetermined time to check whether the obstacle is still present and whether it is therefore still hindered from performing surface treatment in that area.

15. Method according to claim 14, characterized in that the, or each, mobile robot (10) is instructed to return to areas in which an obstacle was identified after the obstacle has been removed.

16. Method according to claim 15, characterized in that one or more points or parts of a permanent structure having a complex geometry and located in the working area of the, or each mobile robot (10) is marked with reflective material, such as reflective tape, to strengthen the signals reflected from said points or parts to facilitate correspondence between data from the locating means and data from the robot system's map.

17. A computer readable medium, characterized in that it contains computer program code means for making a computer or processor carry out the method according to claim 12.

18. (canceled)

19. A computer readable medium according to claim 17, characterized in that it further comprises computer executable instructions for the emitting means (15) used to treat the surface.

20. A computer readable medium according to claim 17, characterized in that it further contains data stored thereon containing a map of a surface and optionally a pre-programmed path to direct the, or each, mobile robot around that path.

21. (canceled)

22. (canceled)

23. A robot system according to claim 1, characterized in that the, or each mobile robot (10) is programmed to return to an area in which an obstacle was detected after a pre-determined time to check whether the obstacle is still present and whether it is therefore still hindered from performing surface treatment in that area.

24. A robot system according to claim 1, characterized in that the locating means (13,14) comprise at least one of the following types of sensor; optical such as a laser, thermal imaging, electro-magnetic, sonar, GPS, pressure, motion, angle detection, contact or direction sensors.

25. A robot system according to claim 1, characterized in that it comprises means to differentiate between different objects or different parts of the same object by detecting differences in the reflectivity of the different materials constituting those objects.

26. A robot system according to claim 1, characterized in that the, or each, mobile robot (10) comprises wired or wireless communication means such as an electric or optic cable, an antenna or Bluetooth™ hardware to communicate with a remote user, control system or computer network or another robot.

27. A robot system according to claim 1, characterized in that the communication means are arranged to report that an obstacle has been encountered by a mobile robot (10) if the obstacle has not been removed after a pre-determined time such as a few seconds.

28. A robot system according to claim 1, characterized in that the, or each, mobile robot (10) traverses the surface to be treated.

29. A robot system according to claim 1, characterized in that the, or each, mobile robot (10) traverses a surface other than the surface to be treated.

30. A robot system according to claim 1, characterized in that the, or each, mobile robot (10) comprises deletion means, instead of, or in addition to the emitting means (15), which are arranged to remove emissions (17) produced by the emitting means (15) of the same or another mobile robot (10) in the same or a previous run respectively.

31. The robot system of claim 1 wherein the at least one mobile robot is operative for indicating or marking out a physical lay-out on any indoor or outdoor surface such as at an exhibition, a trade fair or construction site.

32. The robot system of claim 1 wherein the at least one mobile robot is operative for marking out a physical lay-out at a site under hazardous or hygienic conditions.

33. A method according to claim 12, characterized in that the, or each, mobile robot (10) is programmed to return to an area in which an obstacle was detected after a predetermined time to check whether the obstacle is still present and whether it is therefore still hindered from performing surface treatment in that area.

34. A method according to claim 12, characterized in that the, or each, mobile robot (10) is instructed to return to areas in which an obstacle was identified after the obstacle has been removed.

35. A method according to claim 12, characterized in that one or more points or parts of a permanent structure having a complex geometry and located in the working area of the, or each mobile robot (10) is marked with reflective material, such as reflective tape, to strengthen the signals reflected from said points or parts to facilitate correspondence between data from the locating means and data from the robot system's map.

36. The method of claim 12 further comprising marking out a physical lay-out at a site under hazardous or hygienic conditions by the at least one robot.

37. The method of claim 12 further comprising marking out a physical lay-out at a site under hazardous or hygienic conditions by the at least one robot.
